(19) United States
(12) Patent Application Publication
(10) Pub. No.: US 2013/0262603 A1
(43) Pub. Date: Oct. 3, 2013

(54) DATA PROCESSING APPARATUS AND COMPUTER READABLE MEDIUM

(71) Applicant: CASIO COMPUTER CO., LTD., Tokyo (JP)

(72) Inventors: Teruo Inoue, Tokyo (JP); Koji Nishitani, Tokyo (JP)

(73) Assignee: CASIO COMPUTER CO., LTD., Tokyo (JP)

(21) Appl. No.: 13/850,504

(22) Filed: Mar. 26, 2013

(30) Foreign Application Priority Data
Mar. 28, 2012 (JP) 2012-073457

(51) Int. Cl. H04L 12/24

(52) U.S. Cl. CPC H04L 41/026
USPC 709/206

(57) ABSTRACT

A data processing apparatus includes a reception unit, a processor, a storage controller and a reception controller. The reception unit checks for an e-mail sent to the apparatus at a predetermined time interval, and, when the e-mail sent to the apparatus exists, receives the e-mail. The processor performs processing in accordance with a command when the received e-mail includes the command. The storage controller stores a receipt time of the e-mail including the command on a storage unit. The reception controller makes an interval between the checks of e-mails shorter than the predetermined time interval at and within a predetermined time before and after a time corresponding to the receipt time stored in the storage unit.

### BACKGROUND OF THE INVENTION

1. Field of the Invention

The present invention relates to a data processing apparatus and a computer readable medium.

2. Background Art

In general, shops which offer commodities and services have a register to record commodities purchased by customers, proceeds from sales, or the like. As a technique of external operation of a register, there has been known a method for remotely controlling a Windows-based register (Windows: registered trademark) directly through a remote desktop system with a remote desktop server running.

Such an external control of a register requires complex configurations, such as setting the IP address of the register to a static IP address, using a dynamic DNS (dynamic domain name system), and setting NAT (network address translator) traversal of a router.

As another technique of external operation of a register, there has been known a method where an e-mail including a command is sent to a register and where the register executes the processing corresponding to the command.

Japanese Patent No. 3676684 proposes a technique of receiving external control instructions via e-mails, for example. More specifically, the document discloses an e-mail process server to analyze the message of a received e-mail, performs the processing in accordance with the message of the e-mail, and sends the results via e-mail.

In some cases, however, such a register cannot timely execute the processing in accordance with a command included in an e-mail, depending on the timing at which the register checks for an e-mail on an e-mail server.

At shops having a register, the times of beginning and ending, the time at which various configurations of a register are changed, the time at which an owner looks over a sales report and the like are roughly fixed in general depending on shops and owners. When an e-mail which instructs a register to transmit a sales report is sent to the register from an external device, however, the reply may be up to five minutes late, for example, in the case where the register is configured to receive an e-mail at five-minute intervals.

If a register is configured to check for an e-mail on an e-mail server at shorter intervals in advance, there is a problem of increase in processing load.

### SUMMARY OF THE INVENTION

An object of the present invention is to provide an apparatus that can receive necessary e-mails without fail and can timely process control instructions from an external device, with the processing load reduced.

According to an aspect of the present invention, there is provided a data processing apparatus including: a reception unit which checks for an e-mail sent to the apparatus at a predetermined time interval, and, when the e-mail sent to the apparatus exists, receives the e-mail; a processor which performs processing in accordance with a command when the e-mail received by the reception unit includes the command; a storage controller which stores a receipt time of the e-mail including the command on a storage unit; and a reception controller which makes an interval between checks of e-mails by the reception unit shorter than the predetermined time interval at and within a predetermined time before and after a time corresponding to the receipt time stored in the storage unit.

According to another aspect of the present invention, there is provided a non-transitory computer readable medium having stored thereon computer-executable instructions which, when executed, cause a computer to perform steps of: checking for an e-mail sent to the apparatus at a predetermined time interval, and, when the e-mail sent to the apparatus exists, receiving the e-mail; performing processing in accordance with a command when the received e-mail includes the command; storing a receipt time of the e-mail including the command on a storage unit; and making an interval between the checks of e-mails shorter than the predetermined time interval at and within a predetermined time before and after a time corresponding to the receipt time stored in the storage unit.

### BRIEF DESCRIPTION OF THE DRAWINGS

The above and other objects, advantages and features of the present invention will become more fully understood from the detailed description given hereinbelow and the appended drawings which are given by way of illustration only, and thus are not intended as a definition of the limits of the present invention, and wherein:

FIG. 1 is a configuration diagram of a register control system in accordance with a first embodiment;

FIG. 2 is a block diagram showing the functional configuration of a sales data processing apparatus in accordance with the first embodiment;

FIG. 3 is a flowchart showing e-mail reception processing to be performed in the sales data processing apparatus;

FIG. 4 is a flowchart showing the e-mail reception processing to be performed in the sales data processing apparatus;

FIG. 5 is a block diagram showing the functional configuration of a sales data processing apparatus in accordance with a second embodiment;

FIG. 6 illustrates a data structure of a four-week memory;

FIG. 7 is a flowchart showing e-mail reception processing A to be performed in the sales data processing apparatus;

FIG. 8 is a flowchart showing bit location calculation processing;

FIG. 9 is a flowchart showing four-week bit-value calculation processing; and

FIG. 10 is a flowchart showing adjustment processing to be performed in the sales data processing apparatus.

### DETAILED DESCRIPTION OF THE PREFERRED EMBODIMENTS

### First Embodiment

A first embodiment in accordance with the present invention is described below with reference to the drawings. The present invention is not limited to the example shown in the drawings.

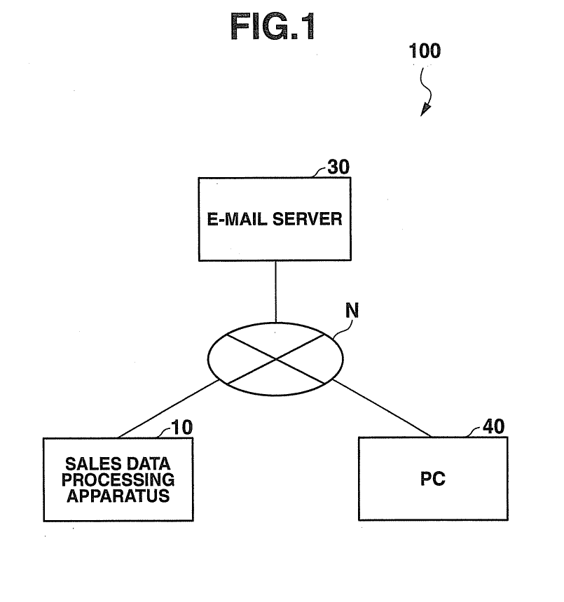

FIG. 1 illustrates the configuration of a register control system 100. The register control system 100 includes a sales data processing apparatus 10 as a data processing apparatus, an e-mail server 30 and a personal computer (PC) 40.

The e-mail server 30 is connected with the sales data processing apparatus 10 and the PC 40 via a communication network N such that the e-mail server 30 can send/receive data to/from the apparatus 10 and the PC 40.

The communication network N is an information communication network which is built using a dedicated line, an existing public line, the Internet or the like. The number of the sales data processing apparatuses 10 is not particularly limited.

The examples of the sales data processing apparatus 10 include a cash register, an electronic register and a point-of-sale (POS) terminal.

The sales data processing apparatus 10, which is installed in a shop, registers sales data such as names of commodities purchased by customers, sales figures of commodities and proceeds from sales. When receiving an e-mail including a command, the sales data processing apparatus 10 performs processing in accordance with the command.

The e-mail server 30 is a computer device to send and receive e-mails. The e-mail server 30 stores e-mails sent to users including the sales data processing apparatus 10, and sends an e-mail to each user in response to each user's e-mail checking (request for reception).

The PC 40 is a computer device to be used by an owner of a shop, and is used for sending/receiving e-mails to/from the sales data processing apparatus 10.

An e-mail sent from the PC 40 to the sales data processing apparatus 10 is stored in the e-mail server 30, and sent to the sales data processing apparatus 10 in response to e-mail checking by the sales data processing apparatus 10.

An e-mail addressed to an owner from the sales data processing apparatus 10 is sent to an e-mail server which stores e-mails addressed to the owner, via the e-mail server 30. The e-mail server for the owner's e-mails may be the e-mail server 30 itself.

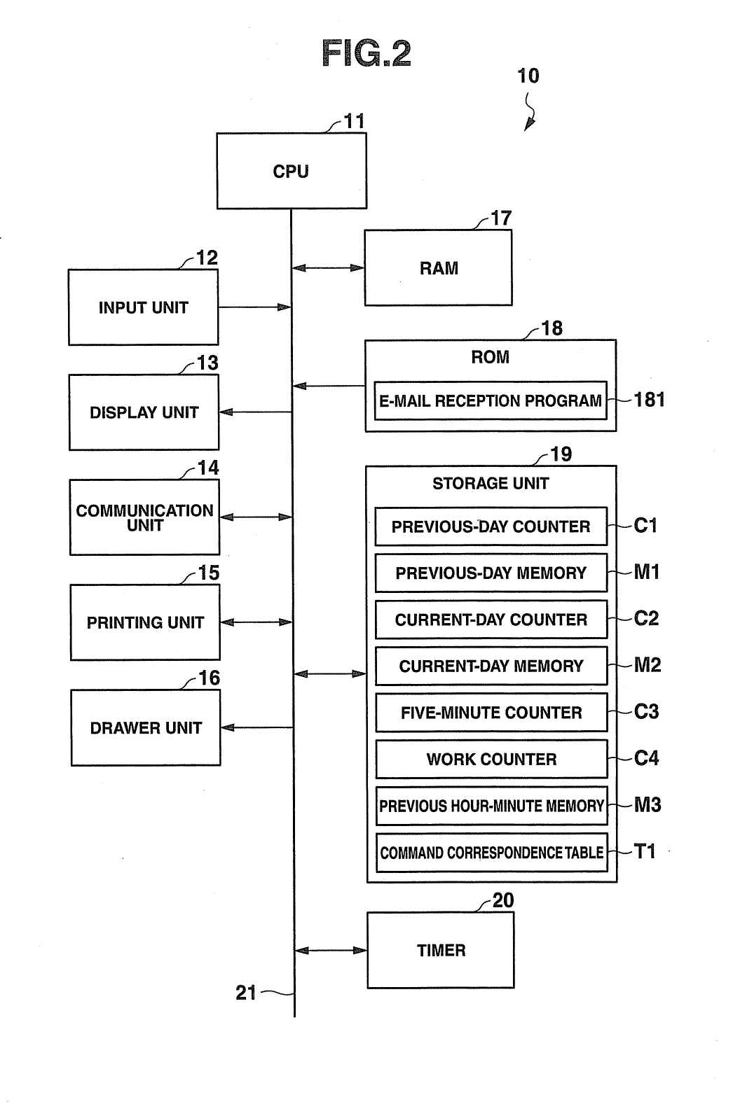

FIG. 2 is a block diagram showing the functional configuration of the sales data processing apparatus 10.

The sales data processing apparatus 10 includes a processor, a storage controller, a central processing unit (CPU) 11 as a reception controller, an input unit 12, a display unit 13, a communication unit 14 as a reception unit, a printing unit 15, a drawer unit 16, a random access memory (RAM) 17, a read only memory (ROM) 18, a storage unit 19 and a timer 20. The units are connected with one another via a bus 21.

The CPU 11 performs an overall control of the operation of each unit of the sales data processing apparatus 10. More specifically, the CPU 11 reads various processing programs stored in the ROM 18, expands the read programs into the RAM 17, and performs various types of processing in cooperation with the programs.

The CPU 11 controls the communication unit 14 to check for an e-mail sent to the apparatus 10 on the e-mail server 30 at predetermined time intervals (i.e., at five-minute intervals in the first embodiment). When an e-mail sent to the apparatus 10 exists, the CPU 11 controls the communication unit 14 to receive the e-mail.

When an e-mail received by the communication unit 14 includes a command, the CPU 11 performs the processing in accordance with the command and stores the receipt time of the e-mail including the command on the storage unit 19.

At and within a predetermined time (i.e., within ten minutes in the first embodiment) before and after the time corresponding to a receipt time stored in the storage unit 19, the CPU 11 makes an interval between checks of e-mails, which is performed by the communication unit 14, shorter than a predetermined time interval (i.e., shortened to one minute in the first embodiment).

More specifically, the CPU 11 controls an interval between checks of e-mails with reference to a receipt time of the previous day stored in the storage unit 19.

The input unit 12 includes a keyboard for a register, which input unit 12 includes a power source key, cursor keys, character input keys, number input keys, and various function keys. The input unit 12 outputs an operation signal for each key to the CPU 11 when operated by an operator.

The input unit 12 also includes a bar code reader, a bar code scanner or the like which reads bar codes on commodities and outputs the read data to the CPU 11.

The display unit 13 is constituted of a liquid crystal display (LCD), an electro-luminescent display (ELD) or the like, and displays a screen in accordance with a display control signal from the CPU 11.

The communication unit 14 is constituted of a network interface or the like, and sends/receives data to/from an external device connected to the communication unit 14 via a communication network N. The communication unit 14 sends/receives e-mails to/from the e-mail server 30, for example.

The printing unit 15 is constituted of a printer such as a thermal printer. The printing unit 15 includes a roll of paper for receipts and journals, and prints the data of an amount of money, for example, on the paper in accordance with an instruction inputted from the CPU 11.

The drawer unit 16 includes a drawer to store coins and bills, and an opening section to open the drawer. In the drawer unit 16, the opening section opens the drawer in accordance with an instruction of the CPU 11.

The RAM 17 is a volatile memory. The RAM 17 stores various programs to be executed and data related to the programs.

The ROM 18 is a read-only semiconductor memory to store various programs and various types of data. The ROM 18 stores an e-mail reception program 181.

The storage unit 19 is constituted of a hard disk drive (HDD), a non-volatile memory or the like. Information can be written on the storage unit 19 to be stored therein, and can be read therefrom. More specifically, the storage unit 19 includes a previous-day counter C1, a previous-day memory M1, a current-day counter C2, a current-day memory M2, a five-minute counter C3, a work counter C4 and a previous hour-minute memory M3.

The previous-day counter C1 stores the number of times an e-mail including a command was received in the previous day.

The previous-day memory M1 stores the receipt times (HH:MM) at which e-mails including a command were received in the previous day. Each receipt time (HH:MM) ranges from 00:00 to 23:59.

The current-day counter C2 stores the number of times an e-mail including a command is received in a current day.

The current-day memory M2 stores the receipt times (HH:MM) at which e-mails including a command are received in a current day.

The five-minute counter C3 is a counter which measures five minutes, which is a usual reception interval.

The work counter C4 is a counter which identifies a receipt time in the previous-day memory M1 to be compared to a current time.

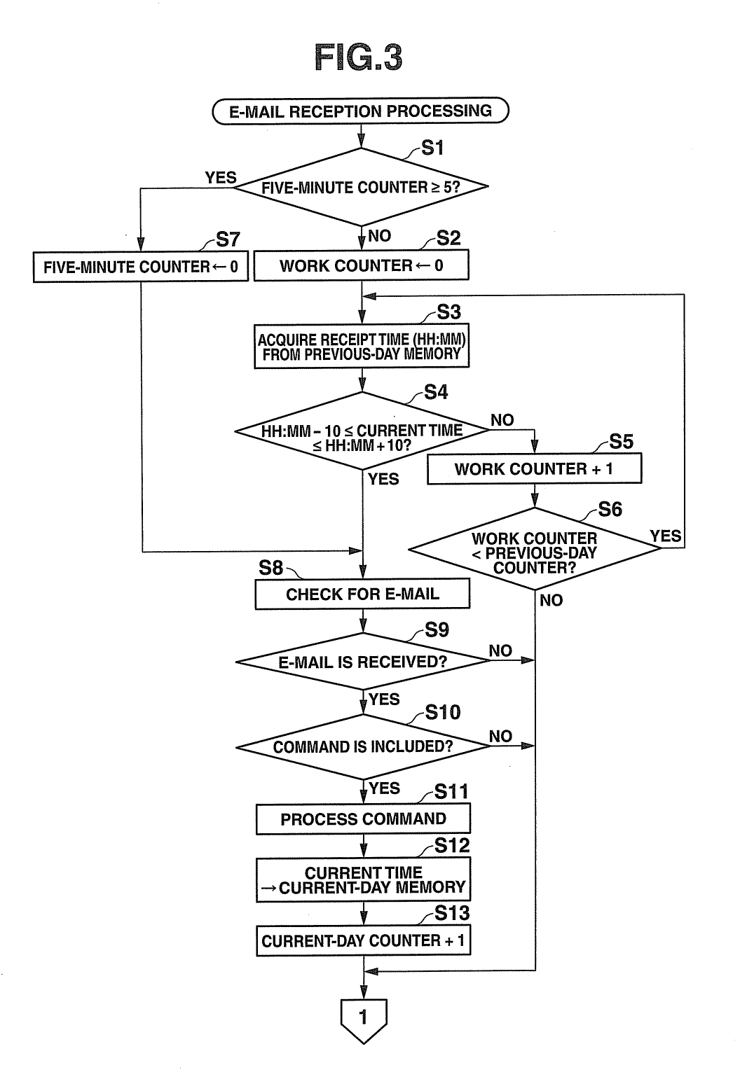

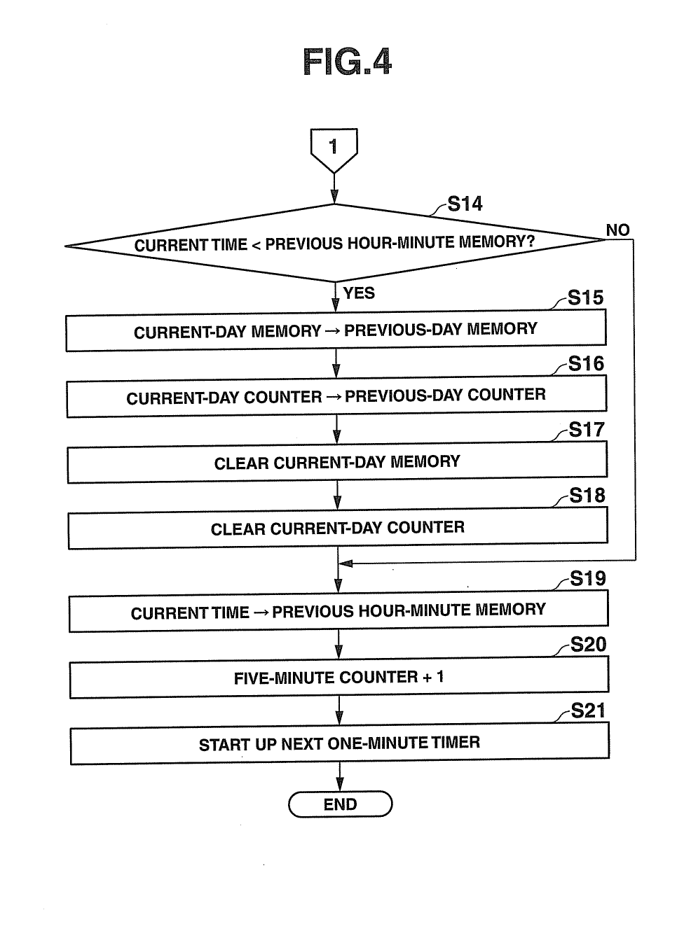

The previous hour-minute memory M3 is a memory into which a current time is stored every one minute in e-mail reception processing (see FIGS. 3 and 4; described later)

Further, the storage unit 19 stores a command correspondence table T1. In the command correspondence table T1, each command is connected with processing instructed by the command.

As a command, a character string is set in advance, which character string is common to a sender and a receiver of a command. Examples of a command include a price change command, a message change command, a sales report transmission command and a setting report transmission command.

In the case of the price change command, a transmitted e-mail includes a name and price of a commodity. When a received e-mail includes the price change command, the CPU 11 changes the price of the commodity having the name into a specified price.

In the case of the message change command, a transmitted e-mail includes a message. When a received e-mail includes the message change command, the CPU 11 replaces a message existing in the sales data processing apparatus 10 with the message included in the received e-mail.

In the case of the sales report transmission command or the setting report transmission command, a transmitted e-mail includes what type of sales report or what type of setting report to be sent back. When a received e-mail includes the sales report transmission command or the setting report transmission command, the CPU 11 sends a report in accordance with the type of report.

The timer 20 includes a timing circuit (real time clock, RTC). The timer 20 obtains a current date and a current time with the timing circuit, and outputs them to the CPU 11.

Next, the operation in the sales data processing apparatus 10 is described.

FIGS. 3 and 4 are a flowchart showing e-mail reception processing to be performed in the sales data processing apparatus 10. This processing is executed every one minute, and realized by software processing performed through cooperation between the CPU 11 and the e-mail reception program 181 stored in the ROM 18.

First, the CPU 11 determines whether the counter value of the five-minute counter C3 of the storage unit 19 is five or larger (Step S1). If the counter value of the five-minute counter C3 is smaller than five (Step S1: NO), the CPU 11 set the counter value of the work counter C4 of the storage unit 19 to zero (Step S2).

Next, the CPU 11 acquires a receipt time (HH:MM) at the position corresponding to the counter value of the work counter C4 from the previous-day memory M1 of the storage unit 19 (Step S3).

Next, the CPU 11 acquires a current time from the timer 20, and determines whether the current time is at or within ten minutes before or after the receipt time acquired at Step S3 (Step S4).

If the current time is not at or within ten minutes before or after the receipt time acquired at Step S3 (Step S4: NO), the CPU 11 adds one to the counter value of the work counter C4 of the storage unit 19 (Step S5).

Next, the CPU 11 determines whether the counter value of the work counter C4 of the storage unit 19 is smaller than the counter value of the previous-day counter C1 of the storage unit 19 (Step S6). That is, the CPU 11 determines whether there is a receipt time of the previous day, for which the comparison with the current time (Step S4) has not yet been done, among the receipt times stored in the previous-day memory M1.

If the counter value of the work counter C4 is smaller than the counter value of the previous-day counter C1 (Step S6: YES), the CPU 11 goes back to Step S3 and repeats the processing.

If the counter value of the five-minute counter C3 is five or larger at Step S1 (Step S1: YES), the CPU 11 sets the counter value of the five-minute counter C3 of the storage unit 19 to zero (Step S7).

If the current time is at or within ten minutes before or after the receipt time acquired at Step S3 (Step S4: YES) or after Step S7, the CPU 11 checks for an e-mail, which is sent to the sales data processing apparatus 10, on the e-mail server 30 via the communication unit 14 (Step S8).

If an e-mail sent to the sales data processing apparatus 10 exists on the e-mail server 30, the CPU 11 receives the e-mail via the communication unit 14.

Next, the CPU 11 determines whether an e-mail sent to the sales data processing apparatus 10 is received via the communication unit 14 (Step S9). If an e-mail sent to the sales data processing apparatus 10 is received (Step S9: YES), the CPU 11 determines whether the received e-mail includes a command (Step S10). A command is included in a subject of an e-mail, for example.

If the received e-mail includes a command (Step S10: YES), the CPU 11 refers to the command correspondence table T1 stored in the storage unit 19 and reads the processing which is connected to the command to perform the processing in accordance with the command (Step S11).

In accordance with a command, the CPU 11 executes processing such as change of setting data (price or message, for example) in the sales data processing apparatus 10; and transmission of a sales report or a setting report.

Next, the CPU 11 acquires a current time from the timer 20 and stores the current time on the current-day memory M2 of the storage unit 19 (Step S12). Then, the CPU 11 adds one to counter value of the current-day counter C2 of the storage unit 19 (Step S13). Thus, the receipt time of the e-mail including a command is stored in the current-day memory M2.

If the counter value of the work counter C4 is equal to or larger than the counter value of the previous-day counter C1 at Step S6 (Step S6: NO); if an e-mail sent to the sales data processing apparatus 10 is not received at Step S9 (Step S9: NO); if the received e-mail does not include a command at Step S10 (Step S10: NO); or after Step S13, the CPU 11 moves on to Step S14 in FIG. 4.

The CPU 11 acquires a current time from the timer 20, and determines whether the current time is prior to the time stored in the previous hour-minute memory M3 of the storage unit 19 (Step S14). In other words, the CPU 11 determines whether the current time is after 00:00 (i.e., whether the date has changed).

If the current time is prior to the time stored in the previous hour-minute memory M3, i.e., if the date has changed from the time stored in the previous hour-minute memory M3 at Step S14 (Step S14: YES), the CPU 11 stores the receipt times stored in the current-day memory M2 of the storage unit 19 on the previous-day memory M1 of the storage unit 19 (Step S15), and stores the counter value of the current-day counter C2 of the storage unit 19 on the previous-day counter C1 of the storage unit 19 (Step S16).

Next, the CPU 11 clears the current-day memory M2 of the storage unit 19 (Step S17), and clears the current-day counter C2 of the storage unit 19 (Step S18). More specifically, the CPU 11 deletes all the receipt times stored in the current-day memory M2 of the storage unit 19 (initialization of the current-day memory M2), and sets the counter value of the current-day counter C2 of the storage unit 19 to zero (initialization of the current-day counter C2).

If the current time is at or after the time stored in the previous hour-minute memory M3, i.e., if the date has not been changed from the time stored in the previous hour-minute memory M3 at Step S14 (Step S14: NO); or after Step S18, the CPU 11 acquires a current time from the timer 20 and stores the current time on the previous hour-minute memory M3 of the storage unit 19 (Step S19).

Next, the CPU 11 adds one to the counter value of the five-minute counter C3 of the storage unit 19 (Step S20), and starts up the next one-minute timer (Step S21). When one minute has passed, the e-mail reception processing is ended.

As described above, according to the first embodiment, the CPU 11 of the sales data processing apparatus 10 checks for an e-mail sent to the apparatus 10 via the communication unit 14 usually at five-minute intervals, and, when an e-mail sent to the apparatus 10 exists, receives the e-mail.

When the received e-mail includes a command, the CPU 11 performs the processing in accordance with the command, and stores the receipt time of the e-mail on the current-day memory M2 of the storage unit 19.

When a date has changed, the CPU 11 stores the receipt times stored in the current-day memory M2 on the previous-day memory M1 of the storage unit 19.

At and within ten minutes before and after the time corresponding to a receipt time stored in the previous-day memory M1, the CPU 11 shortens an interval between checks of e-mails from five minutes to one minute.

Thus, an interval between checks of e-mails is made shorter than usual within a period of time when the apparatus 10 is likely to receive an e-mail including a command. This reduces processing load and allows the apparatus 10 to receive necessary e-mails without fail and to timely process an external control instruction.

Further, the CPU 11 controls an interval between checks of e-mails with reference to a receipt time of the previous day stored in the previous-day memory M1. Accordingly, an interval between checks of e-mails can be made shorter than usual in the period of time corresponding to a time when an e-mail including a command was received on the previous day.

In the first embodiment, the CPU 11 controls an interval between checks of e-mails with reference to the receipt time of an e-mail including a command of the previous day. Alternatively, receipt times of e-mails including a command for a few days may be stored. In this case, an interval between checks of e-mails may be made shorter than usual at and within a predetermined time before and after a time corresponding to any of the receipt times for the days.

### Second Embodiment

Next, a second embodiment to which the present invention is applied is described.

Since the register control system in the second embodiment has the same structures as the register control system 100 shown in the first embodiment, FIG. 1 is shared for the first and second embodiments, and the explanations for the structures in this figure are omitted here.

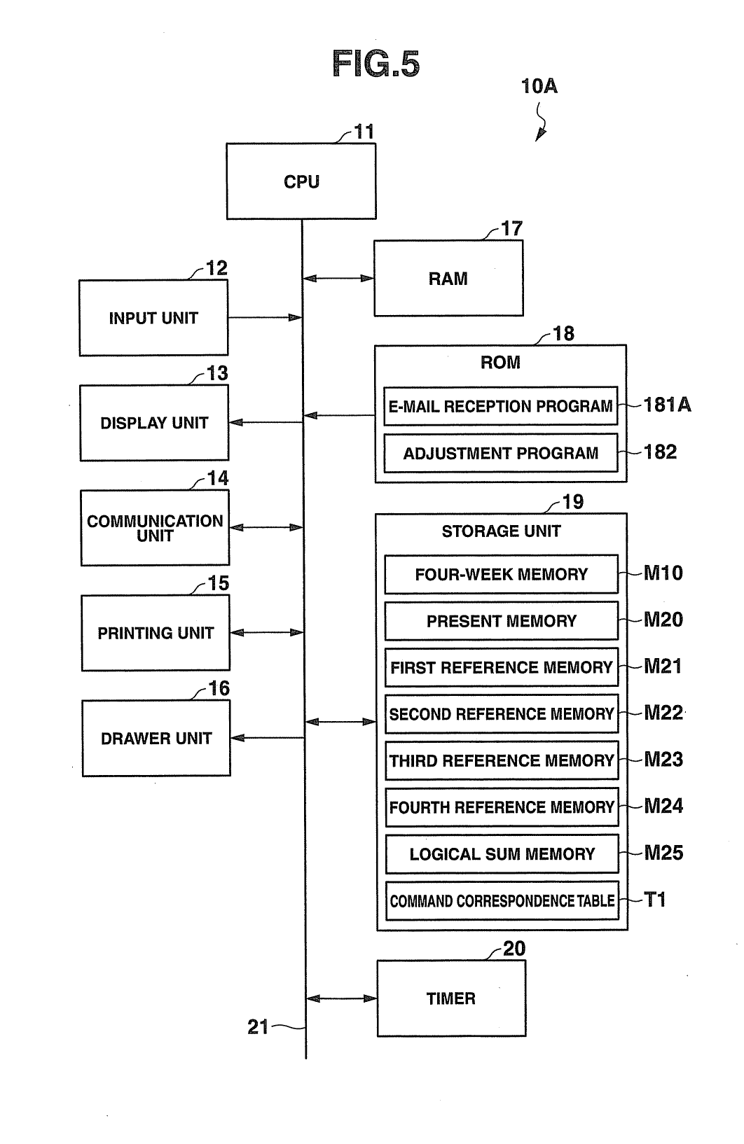

In the second embodiment, a sales data processing apparatus 10A shown in FIG. 5 is used instead of the sales data processing apparatus 10 in the first embodiment.

The same numbers or alphabets are assigned to the same components between the sales data processing apparatus 10A and the sales data processing apparatus 10, and repetitive explanations are omitted.

The sales data processing apparatus 10A includes a CPU 11, an input unit 12, a display unit 13, a communication unit 14, a printing unit 15, a drawer unit 16, a RAM 17, a ROM 18, a storage unit 19 and a timer 20. These units are connected with one another via a bus 21.

The distinctive structures and processing of the second embodiment are described below.

The CPU 11 controls the communication unit 14 to check for an e-mail sent to the apparatus 10A on the e-mail server 30 at predetermined time intervals (at five-minute intervals in the second embodiment). When an e-mail sent to the apparatus 10A exists, the CPU 11 controls the communication unit 14 to receive the e-mail.

When an e-mail received by the communication unit 14 includes a command, the CPU 11 performs the processing in accordance with the command and stores the receipt time of the e-mail including the command on the storage unit 19.

At and within a predetermined time (i.e., within ten minutes in the second embodiment) before and after the time corresponding to receipt times stored in the storage unit 19, the CPU 11 makes the interval between checks of e-mails, which is performed by the communication unit 14, shorter than a predetermined time interval (i.e., shortened to one minute or two minutes in the second embodiment).

Specifically, the CPU 11 controls an interval between checks of e-mails by the communication unit 14 with reference to the receipt times within a predetermined period of time (i.e., four weeks in the second embodiment) stored in the storage unit 19.

More specifically, the CPU 11 controls an interval between checks of e-mails by the communication unit 14 with reference to the receipt times of the days, which are the same day of the week, within the predetermined period of time stored in the storage unit 19.

The CPU 11 determines an interval between checks of e-mails by the communication unit 14 in accordance with the degree of urgency of a command.

More specifically, when the command included in an e-mail requests a reply, the CPU 11 judges that the e-mail has a high degree of urgency, and the CPU 11 sets an interval between checks of e-mails by the communication unit 14 to one minute.

On the other hand, when the command included in an e-mail does not request a reply, the CPU 11 judges that the e-mail has a low degree of urgency, and the CPU 11 sets an interval between checks of e-mails by the communication unit 14 to two minutes.

The ROM 18 stores an e-mail reception program 181A and an adjustment program 182.

The storage unit 19 includes a four-week memory M10, a present memory M20, a first reference memory M21, a second reference memory M22, a third reference memory M23, a fourth reference memory M24 and a logical sum memory M25.

The four-week memory M10 is a memory that stores receipt times of e-mails including a command in the last four weeks, and timings for checking e-mails which are added owing to the receptions of the e-mails including a command.

The data storage area for a current day in the four-week memory M10 stores the timings for checking e-mails sent to the apparatus 10A at predetermined time intervals (e.g., at five-minute interval).

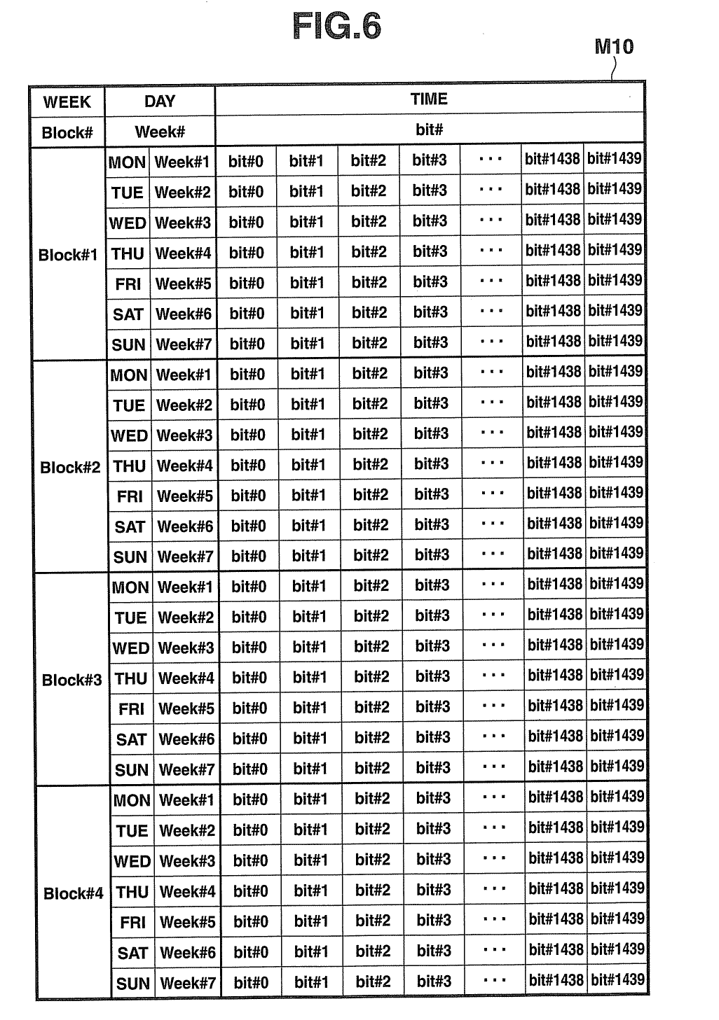

FIG. 6 illustrates a data structure of the four-week memory M10. In the four-week memory M10, a data storage area is identified by a week number Block#, a day number Week# and a time number bit#.

The week number Block# indicates information of week, and corresponds to what number week from a starting date a target day is in. After storage of data is done for Block#4, the Block# returns to Block#1 and data is overwritten in series.

The day number Week# indicates information of the day of the week, and the Week#1 to Week#7 correspond to Monday to Sunday, respectively.

The time number bit# indicates information of times in one day (xx:yy). Data for one day is constituted of 1440 bits since one day is constituted of 1440 minutes (60 (minutes)×24 (hours)). The bit#0 to bit#1439 correspond to 00:00 to 23:59, respectively, and have a bit value of “0” or “1”. The bit value “1” represents performing a check of an e-mail.

The present memory M20 stores the week number Block#, the day number Week# and the time number bit# which corresponds to a current time.

The first reference memory M21 stores the week number Block#1, the day number Week# identical to the day number Week# stored in the present memory M20, and the time number bit# identical to the time number bit# stored in the present memory M20.

The second reference memory M22 stores the week number Block#2, the day number Week# identical to the day number Week# stored in the present memory M20, and the time number bit# identical to the time number bit# stored in the present memory M20.

The third reference memory M23 stores the week number Block#3, the day number Week# identical to the day number Week# stored in the present memory M20, and the time number bit# identical to the time number bit# stored in the present memory M20.

The fourth reference memory M24 stores the week number Block#4, the day number Week# identical to the day number Week# stored in the present memory M20, and the time number bit# identical to the time number bit# stored in the present memory M20.

The logical sum memory M25 stores the logical sum of the bit value (“0” or “1”) of the bit location represented by the week number Block#1, the day number Week# and the time number bit# stored in the first reference memory M21; bit value (“0” or “1”) of the bit location represented by the week number Block#2, the day number Week#, and the time number bit# stored in the second reference memory M22; bit value (“0” or “1”) of the bit location represented by the week number Block#3, the day number Week#, and the time number bit# stored in the third reference memory M23; and bit value (“0” or “1”) of the bit location represented by the week number Block#4, the day number Week#, and the time number bit# stored in the fourth reference memory M24.

That is, when any of the bit values of the bit locations represented by the week numbers Blocks#, the day numbers Weeks#, and the time numbers bits# stored in the first to fourth reference memories M21 to M24 is “1”, the logical sum is “1”; and all of the bit values of the bit locations represented by the week numbers Blocks#, the day numbers Weeks#, and the time numbers bits # stored in the first to fourth reference memories M21 to M24 are “0”, the logical sum is “0”.

Further, the storage unit 19 stores a command correspondence table T1. The command correspondence table T1 of the second embodiment is the same as that of the first embodiment.

Next, the operation in the sales data processing apparatus 10A is described.

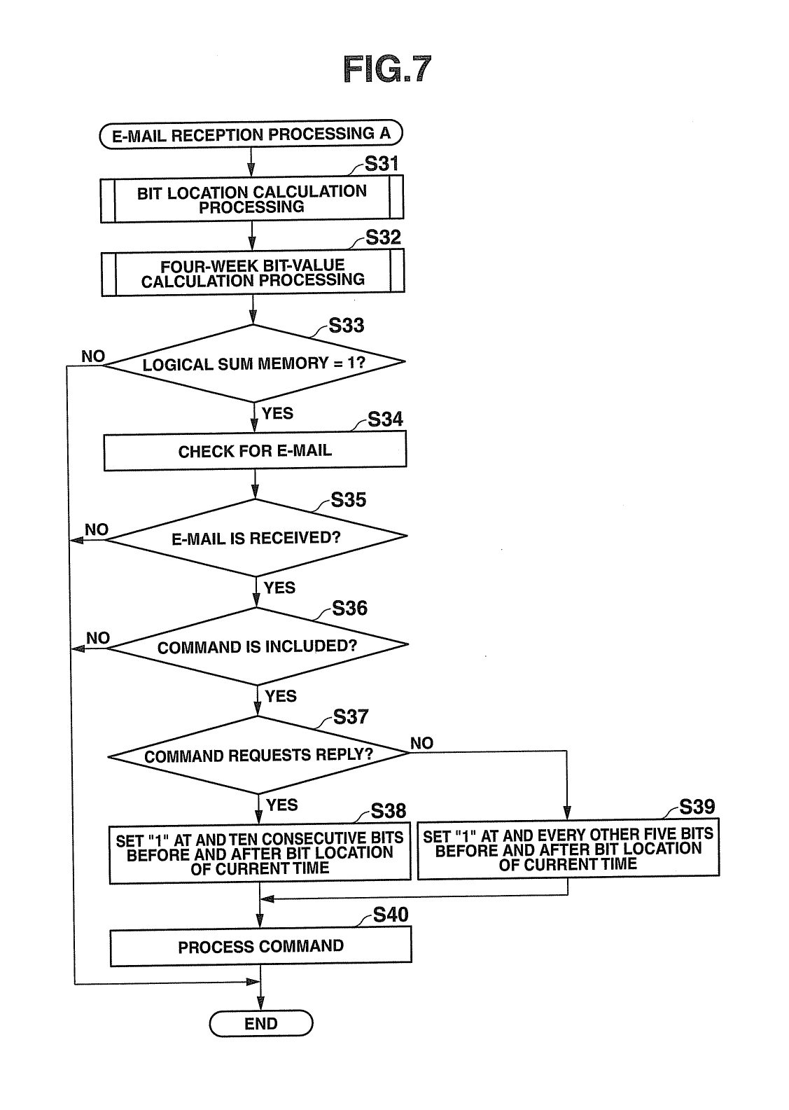

FIG. 7 is a flowchart showing e-mail reception processing A to be performed in the sales data processing apparatus 10A.

This processing is executed every one minute, and realized by software processing performed through cooperation between the CPU 11 and the e-mail reception program 181A stored in the ROM 18.

First, the CPU 11 performs bit location calculation processing (Step S31).

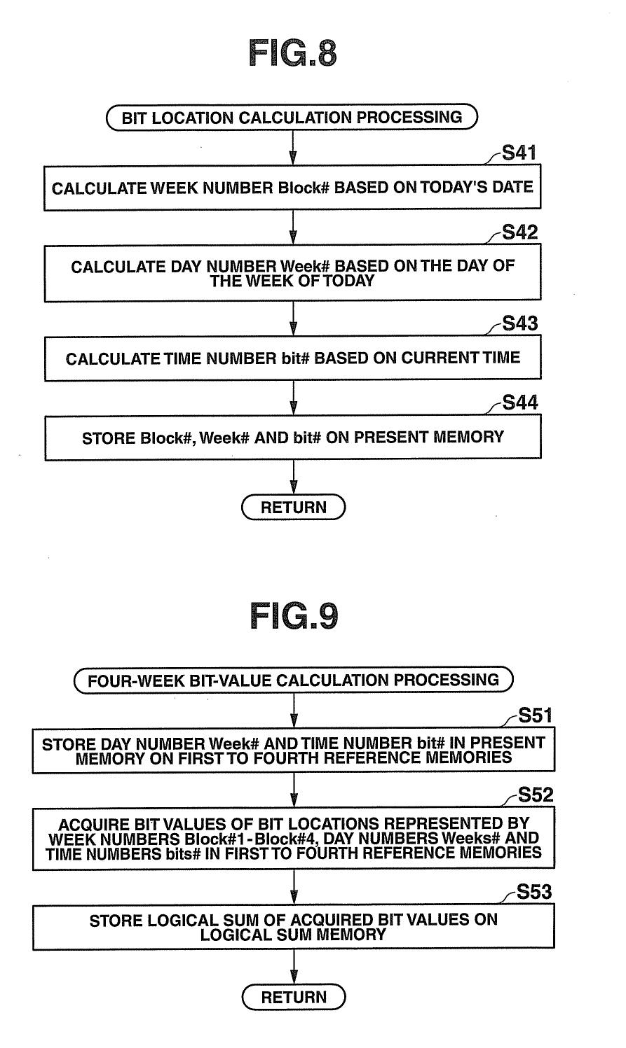

Now, the explanations for the bit location calculation processing are given with reference to FIG. 8.

The CPU 11 acquires a current date from the timer 20 and calculates a week number Block# based on today's date (Step S41).

In concrete terms, the number of days from a starting date to today is calculated using the DATEDIF function of the EXCEL function, and more specifically, by inputting DATEDIF (“starting date”, “today's date”, “D”). For example, in the case where a starting date is Jan. 4, 2010 (Monday), the number of days from the starting date to Sep. 30, 2011 is 634.

Next, the number of days from the starting date to today is divided by seven. The integer obtained from the division is the number of weeks from the starting date to today. For example, in the example shown above, INT (634/7)=90 holds when the INT function is used. This means, “today” is in the 90^{th} week from the starting date.

Since the four-week memory M10 includes four buffers (Block#1 to Block#4) for the respective weeks, the number of weeks from the starting date to today is divided by four and the remainder is obtained, using the MOD function. The value obtained by adding one to the remainder is a week number Block#. For example, in the example shown above, MOD (90, 4)=2 holds. This means Block#3 is used.

Next, the CPU 11 calculates a day number Week# based on the day of the week of today (Step S42).

More specifically, the CPU 11 calculates the day number Week# for today using the WEEKDAY function of the EXCEL function. For example, in the case of Sep. 30, 2011, WEEKDAY (DATE (2011, 9, 30), 2)=5. This means the date is Friday, which corresponds to Week#5.

Next, the CPU 11 acquires a current time from the timer 20, and calculates a time number bit# from the current time (Step S43)

When the current time is 15:25, for example, 15×60+25=925 holds. This means the bit location corresponding to the current time is 925^{th} bit.

As described above, in the case where a starting date is Jan. 4, 2010 and the current time is Sep. 30, 2011, 15:25, the bit location is determined to be Block#3, Week#5,bit#925.

Next, the CPU 11 stores the week number Block#, the day number Week# and the time number bit#, which is calculated at Steps S41 to S43, on the present memory M20 of the storage unit 19 (Step S44).

This is the end of the bit location calculation processing.

Returning to FIG. 7, the CPU 11 performs four-week bit-value calculation processing (Step S32).

Now, the explanations for the four-week bit-value calculation processing are given with reference to FIG. 9.

the CPU 11 stores the day number Week# and the time number bit# stored in the present memory M20 of the storage unit 19 on the first to fourth reference memories M21-M24 of the storage unit 19 (Step S51).

Next, the CPU 11 acquires, from the four-week memory M10 of the storage unit 19, the bit value of the bit location represented by the week number Block#1, the day number Week# and the time number bit# stored in the first reference memory M21; the bit value of the bit location represented by the week number Block#2, the day number Week# and the time number bit# stored in the second reference memory M22; the bit value of the bit location represented by the week number Block#3, the day number Week# and the time number bit# stored in the third reference memory M23; and the bit value of the bit location represented by the week number Block#4, the day number Week# and the time number bit# stored in the fourth reference memory M24 (Step S52).

In the case of the example shown above, the CPU 11 acquires the bit value of Week#5, bit#925 for each of Block#1, Block#2, Block#3 and Block#4.

Next, the CPU 11 obtains the logical sum (OR value) of the bit values acquired at Step S52, and stores the logical sum on the logical sum memory M25 of the storage unit 19 (Step S53).

This is the end of the four-week bit-value calculation processing.

Returning to FIG. 7, the CPU 11 determines whether the value stored in the logical sum memory M25 of the storage unit 19 is “1” (Step S33).

If the value stored in the logical sum memory M25 is “1” (Step S33: YES), the CPU 11 checks for an e-mail sent to the sales data processing apparatus 10A on the e-mail server 30 via the communication unit 14 (Step S34).

If an e-mail sent to the sales data processing apparatus 10A exists on the e-mail server 30, the CPU 11 receives the e-mail via the communication unit 14.

Next, the CPU 11 determines whether an e-mail sent to the sales data processing apparatus 10A is received via the communication unit 14 (Step S35). If an e-mail sent to the sales data processing apparatus 10A is received (Step S35: YES), the CPU 11 determines whether the received e-mail includes a command (Step S36).

If the received e-mail includes a command (Step S36: YES), the CPU 11 determines whether the command included in the e-mail requests a reply (Step S37).

For example, when the command included in the e-mail is a sales report transmission command or a setting report transmission command, the CPU 11 determines that the command requests a reply. When the command included in the e-mail is a price change command or a message change command, the CPU 11 determines that the command does not request a reply.

If the command included in the e-mail requests a reply (Step S37: YES), the CPU 11 sets “1” at the bit location corresponding to the current time for the current day in the four-week memory M10 of the storage unit 19, and also sets “1” for ten consecutive bits both before and after the bit location (Step S38).

For example, in the case where the time number corresponding to the current time is bit#15, the CPU 11 sets “1” as the bit values of bit#5, bit#6, bit#7, bit#8, bit#9, bit#10, bit#11, bit#12, bit#13, bit#14, bit#15, bit#16, bit#17, bit#18, bit#19, bit#20, bit#21, bit#22, bit#23, bit#24 and bit#25.

If the command included in the e-mail does not request a reply at Step S37 (Step S37: NO), the CPU 11 sets “1” at and every other five bits both before and after the bit location corresponding to the current time for the current day in the four-week memory M10 of the storage unit 19 (Step S39).

For example, in the case where the time number corresponding to the current time is bit#15, the CPU 11 sets “1” as the bit values of bit#5, bit#7, bit#9, bit#11, bit#13, bit#15, bit#17, bit#19, bit#21, bit#23 and bit#25.

When a current time is within 00:00 to 00:09 (bit#0 to #9) at Step S38 or Step S39, the range for which a bit value is set to “1” may extend to the data storage area for the previous day in the four-week memory M10. Also, when a current time is within 23:50 to 23:59 (bit#1430 to #1439), the range for which for the next day in the four-week memory M10.

After Step S38 or Step S39, the CPU 11 refers to the command correspondence table T1 stored in the storage unit 19 and reads the processing which is connected to the command to perform the processing in accordance with the command (Step S40).

If the value stored in the logical sum memory M25 is not “1” at Step S33 (Step S33: NO); if an e-mail sent to the sales data processing apparatus 10A is not received at Step S35 (Step S35: NO); if the received e-mail does not include a command at Step S36 (Step S36: NO); or after Step S40, the e-mail reception processing A is ended.

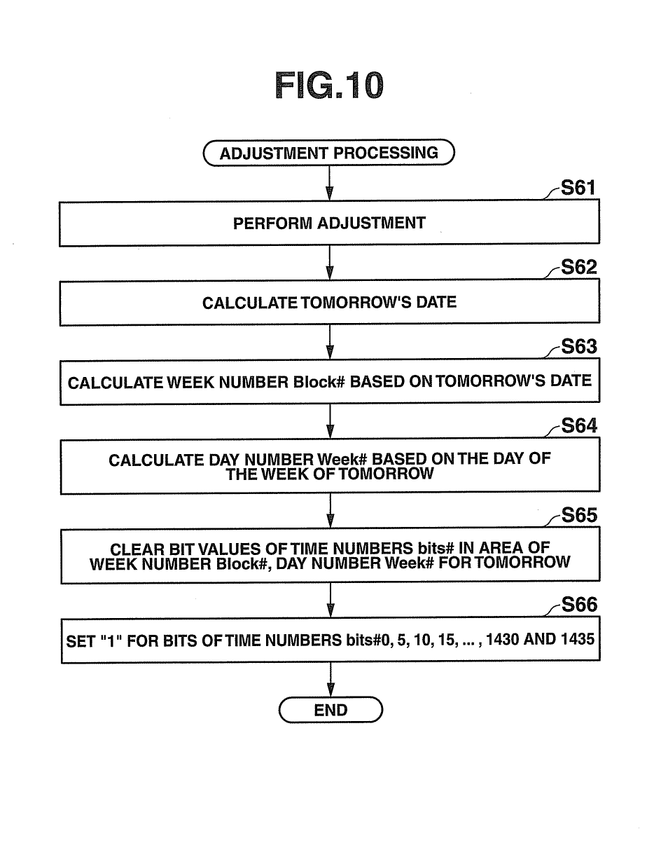

FIG. 10 is a flowchart showing adjustment processing to be performed in the sales data processing apparatus 10A. This processing is executed at the end of a day, and realized by software processing performed through cooperation between the CPU 11 and the adjustment program 182 stored in the ROM 18.

First, the CPU 11 performs an adjustment based on the sales data registered during one day in the sales data processing apparatus 10A (Step S61).

Next, the CPU 11 calculates the date of tomorrow (Step S62). Specifically, for example, the CPU 11 acquires a current date from the timer 20, and adds one to the current date to obtain the date of tomorrow.

Next, the CPU 11 calculates a week number Block# based on the date of tomorrow (Step S63). The process for calculating a week number Block# is the same as Step S41.

Next, the CPU 11 calculates a day number Week# based on the day of the week of tomorrow (Step S64). The process for calculating a day number Week# is the same as Step S42.

Next, the CPU 11 clears the bit values of all the time numbers bits# in the area of the week number Block#, the day number Week# for tomorrow in the four-week memory M10 of the storage unit 19 (Step S65).

Next, the CPU 11 sets “1” for each of the bits of time numbers bits#0, 5, 10, 15, . . . , 1430 and 1435 of the week number Block#, the day number Week# for tomorrow (Step S66). In other words, a usual interval between checks of e-mails is set to five minutes.

This is the end of the adjustment processing.

As described above, according to the second embodiment, the CPU 11 of the sales data processing apparatus 10A checks for an e-mail sent to the apparatus 10A via the communication unit 14 usually at five-minute intervals, and, when an e-mail sent to the apparatus 10A exists, receives the e-mail.

When the received e-mail includes a command, the CPU 11 performs the processing in accordance with the command, and sets “1” at the bit location corresponding to a current time in the four-week memory M10 of the storage unit 19.

That is, the CPU 11 stores the receipt time of an e-mail including a command on the storage unit 19. Further, when a received e-mail includes a command, the CPU 11 sets“1” at one-minute intervals or at two-minute intervals in the data storage area corresponding to the times at and within ten minutes before and after the current time in the four-week memory M10 of the storage unit 19.

In other words, at and within ten minutes before and after the time corresponding to the receipt times stored in the four-week memory M10, the CPU 11 sets an interval between checks of e-mails to one minute or two minutes, shorter than five minutes.

Thus, an interval between checks of e-mails is made shorter than usual within a period of time when the apparatus 10A is likely to receive an e-mail including a command. This reduces processing load and allows the apparatus 10A to receive necessary e-mails without fail and to timely process an external control instruction.

Further, the CPU 11 controls an interval between checks of e-mails with reference to the receipt times for four weeks stored in the four-week memory M10. Accordingly, an interval between checks of e-mails can be made shorter than usual within a period of time when e-mails including a command were received in the last four weeks.

Further, the CPU 11 controls an interval between checks of e-mails with reference to the receipt times of the days, which are the same day of the week, for four weeks stored in the four-week memory M10. Accordingly, an interval between checks of e-mails can be made shorter than usual within a period of time when e-mails including a command were received on the days, which are the same day of the week, in the last four weeks.

Further, the CPU 11 determines an interval between checks of e-mails in accordance with the degree of urgency of a command.

More specifically, the CPU 11 sets “1” at one-minute intervals in the data storage area corresponding to a time at and within ten minutes before and after the current time in the four-week memory M10 of the storage unit 19 when the command included in a received e-mail requests a reply (i.e., when the degree of urgency is high). The CPU 11 sets “1” at two-minute intervals in the data storage area corresponding to a time at and within ten minutes before and after the current time in the four-week memory M10 of the storage unit 19 when the command included in a received e-mail does not request a reply (i.e., when the degree of urgency is low).

When a command instructs the apparatus to transmit a sales report or a setting report, for example, an owner waits for a reply from the apparatus. In such a case, therefore, an interval between checks of e-mails is shortened to one minute at and within ten minutes before and after the time corresponding to the receipt times in the past weeks. This minimizes the waiting time of the owner.

When, on the other hand, a command instructs the apparatus to change setting data, for example, an owner does not wait for a reply but quick execution of the processing corresponding to the command is desirable. In such a case, therefore, an interval between checks of e-mails is shortened to two minutes at and within ten minutes before and after the time corresponding to the receipt times in the past weeks. This can increase the frequency of checks of e-mails than usual.

The above-described embodiments are merely examples of the data processing apparatus in accordance with the present invention, and the present invention is not limited thereto. The detail of configuration and operation of each unit constituting the apparatus may be modified as appropriate without departing from the scope of the invention.

In the above-mentioned embodiments, for example, a usual interval between checks of e-mails is set to five minutes, and a shortened interval is set to one minute or two minutes. These time intervals, however, may be changed as appropriate.

Further, in the above-mentioned embodiments, an interval between checks of e-mails is made shorter than usual when a current time is at or within ten minutes before or after the e-mail receipt time in the past. The “ten minutes”, however, is merely an example and may be changed as appropriate.

Further, the case where an interval between checks of e-mails is controlled with reference to the receipt time of an e-mail including a command in the previous day as in the first embodiment, an interval between checks of e-mails by the communication unit 14 may be shortened in multiple stages depending on the degree of urgency of a command.

For example, when a command requests a reply (i.e., when the degree of urgency is high), an interval between checks of e-mails at and within ten minutes before and after the time corresponding to the receipt time of the previous day is set to one minute; and when a command does not request a reply (i.e., when the degree of urgency is low), an interval between checks of e-mails at and within ten minutes before and after the time corresponding to the receipt time of the previous day is set to two minutes.

In the above description, the ROM 18 is used as a computer readable medium having stored thereon programs to execute various types of processing. The computer readable medium, however, is not limited thereto. Alternatively, a computer readable medium may be a non-volatile memory such as a flash memory or a portable recording medium such as a compact disk read only memory (CD-ROM). Alternatively, a carrier wave may be applied as a medium to provide program data via a communication line.

The scope of the present invention is not limited to the embodiments described above, but covers the scope of the claims and its equivalents.

The entire disclosure of Japanese Patent Application No. 2012-073457 filed on Mar. 28, 2012 including description, claims, drawings, and abstract are incorporated herein by reference in its entirety.

Although various exemplary embodiments have been shown and described, the invention is not limited to the embodiments shown. Therefore, the scope of the invention is intended to be limited solely by the scope of the claims that follow.

What is claimed is:

1. A data processing apparatus comprising:
a reception unit which checks for an e-mail sent to the apparatus at a predetermined time interval, and, when the e-mail sent to the apparatus exists, receives the e-mail;
a processor which performs processing in accordance with a command when the e-mail received by the reception unit includes the command;
a storage controller which stores a receipt time of the e-mail including the command on a storage unit; and
a reception controller which makes an interval between checks of e-mails by the reception unit shorter than the predetermined time interval at and within a predetermined time before and after a time corresponding to the receipt time stored in the storage unit.

2. The data processing apparatus according to claim 1,
wherein the reception controller controls the interval between checks of e-mails by the reception unit with reference to the receipt time of a previous day stored in the storage unit.

3. The data processing apparatus according to claim 1,
wherein the reception controller controls the interval between checks of e-mails by the reception unit with reference to the receipt times within a predetermined period of time stored in the storage unit.

4. The data processing apparatus according to claim 3,
wherein the reception controller controls the interval between checks of e-mails by the reception unit with reference to the receipt times of days within the predetermined period of time stored in the storage unit, the days being a same day of the week.

5. The data processing apparatus according to claim 1,
wherein the reception controller determines the interval between checks of e-mails by the reception unit in accordance with a degree of urgency of the command.

6. A non-transitory computer readable medium having stored thereon computer-executable instructions which, when executed, cause a computer to perform steps of:
checking for an e-mail sent to the apparatus at a predetermined time interval, and, when the e-mail sent to the apparatus exists, receiving the e-mail;
performing processing in accordance with a command when the received e-mail includes the command;
storing a receipt time of the e-mail including the command on a storage unit; and
making an interval between the checks of e-mails shorter than the predetermined time interval at and within a predetermined time before and after a time corresponding to the receipt time stored in the storage unit.
